(19) United States
(12) Patent Application Publication
(10) Pub. No.: US 2017/0180835 A1
(43) Pub. Date: Jun. 22, 2017

(54) Data Cable Management System and Method

(71) Applicant: Scott Forsyth, Sun Valley, NV (US)

(72) Inventor: Scott Forsyth, Sun Valley, NV (US)

(21) Appl. No.: 14/973,660

(22) Filed: Dec. 17, 2015

(51) Int. Cl. H04Q 11/04; H01R 13/502; H01R 13/58; H01B 11/02

(52) U.S. Cl. CPC H04Q 11/0492; H01B 11/02; H01R 13/502; H01R 13/5812; H04Q 11/045

(57) ABSTRACT

A system for organizing network cabling termination while reducing clutter in the media converter is provided. Clutter is reduced because the network provider can consolidate two pieces of cabling termination equipment within one compartment, minimizing space and the number of wires required in the media converter. The system is particularly valuable to office buildings, warehouses, places of educations, hospitals, and other institutions where localized networks are needed. The system is housed within a media converter and includes at least 24 termination ports, an output port, a number of data cables compatible to connect to the termination ports, a single data cable capable of connecting to the output port, and a test port. The media converter box is encased between 2 post racks and secured upon a shelf. When the media convert is set up, network managers can more easily troubleshoot and maintain the localized network server.

### CROSS-REFERENCE TO RELATED APPLICATIONS

None.

### TECHNICAL FIELD

The present invention relates to the art of organizing network cabling termination within office buildings, warehouse, i.e., businesses with a need for multiple data circuit outlets. The invention is a storage panel that houses individual pieces of network equipment in one compartment, minimizing space and maximizing utility of the telecommunications cabling rack or cabinet, thereby allowing an increased number of cables to be connected onto the network.

### BACKGROUND OF THE INVENTION

The current art of operating the a network setup (local area network, wide area network, cloud network, or wireless network) requires multiple patch cords, panels, horizontal and vertical wire mangers to maintain network switches and patch panels. A network switch is a computer networking device that connects devices together on a computer network by processing and forwarding data from multiple devices. A patch panel is a unit having a number of jacks that allows the connection of routing circuits needed for monitoring, interconnecting, and testing of circuits in a network setup. When the patch panel is connected to a network switch, the patch panel is able to transmit the data from the network switch and allows users with computers to access the network. Localized networks are commonly used in office buildings, warehouses, places of education, hospitals, etc. Unlike a purely wireless network, the local area network (LAN) or the wide area network (WAN) are restricted in terms of size and coverage by the size and location of the network setup. Network equipment such as the network switches, multiport media converters, routers, panels, and other cables are separate pieces of instruments connected by cables or through wireless routers. The capacity of the area network grows with the size of the business, and with an increase in coverage, more wires and cables need to be installed onto the circuit board. In order to maximize space and facilitate technical support, this separate equipment is generally stored together in a server room on the premise of the business providing the network. It is common practice for the server room to house the network equipment as well as operate as the information technology office where technicians operate.

As the coverage of the service provided increases, the number of cables and hardware needed increase proportionally. Under the current art, the need for multiple network switches and different wire managers results in the difficult management of cables and wires in the separate patch panels. Also, as more cables and equipment are stored in the server room, it becomes increasingly more cumbersome for technicians to perform maintenance and troubleshooting on the equipment. Aside from the visible abhorrence the current art provokes, the loose cables and equipment presents a serious safety hazard.

### SUMMARY OF THE INVENTION

The present invention comprises a novel media converter or termination circuit board that helps network providers better maintain their network equipments. The present invention is a novel patch panel that houses and consolidates all the loose equipment such as the network switch and various patch panels of a network setup into one piece of equipment that can be affixed to a shelf or cabinet. By introducing a new method to maintain the network, the invention allows for significantly more cables to be installed into a smaller area than the current art. The invention optimizes resources by minimizing dramatically the number of components required, thereby providing a new way to maximize space in a telecommunications cabling rack or cabinet.

### BRIEF DESCRIPTION OF THE DRAWINGS

FIG. 1 is a diagram of the prior art related to the present invention.

FIG. 2 is an isometric view of the patch panel secured onto a shelf by a two-post rack.

FIG. 3 is an isometric view of end users connected to the patch panel through wired cables and the patch panel connecting to a switch board through its output port

FIG. 4 is a top view showing the 2 piece connector.

FIG. 5 shows the strain relief collar.

FIG. 6 is a side view of the 2 piece connector showing the surrounding elements as well.

FIG. 7 shows the prior art of the 2 piece connector.

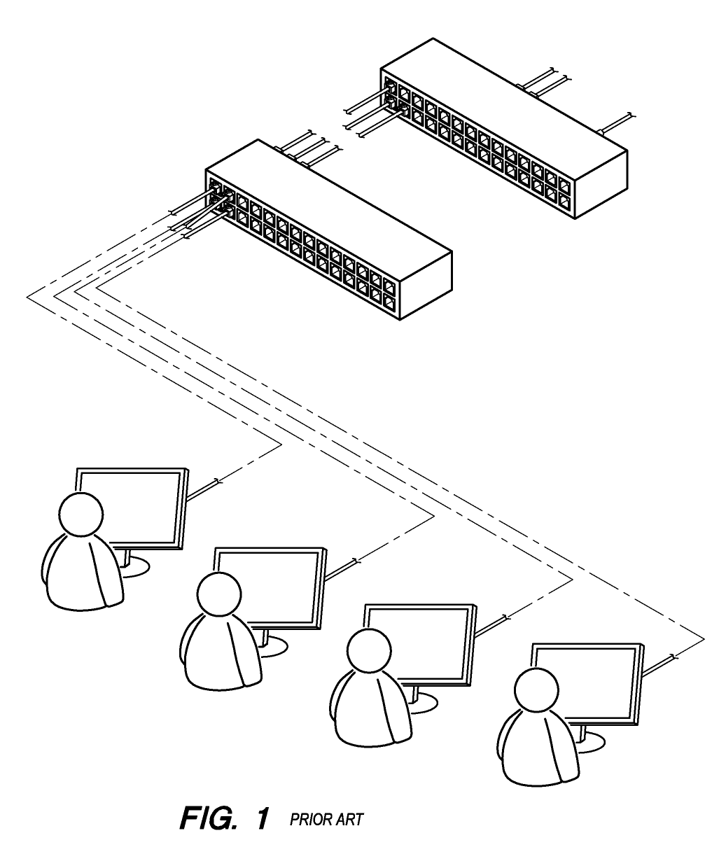

### DETAILED DESCRIPTION OF THE INVENTION

All illustrations of the drawings are for the purpose of describing selected versions of the present invention and are not intended to limit the scope of the present invention.

In the following detailed description of the preferred embodiment, reference is made to the accompanying drawings, which is a part of this application. The drawings show, by way of illustration, specific embodiments in which the invention may be practiced. It is to be understood that other embodiments may be utilized and structural changes may be made without departing from the scope of the present invention.

The following is a listing of the reference numbers included in the original drawings.

The reference numbers correspond to elements of the invention as follows:
1. A media converter
2. At least 24 termination ports on the media converter 1.
3. An output port of the media converter 1.
4. A number of data cables compatible to connect to the termination ports of the media converter
5. A single data cable capable of connecting to the output port 3.
6. A test port on the media converter 1.
7. One or more end users. This could include workstations, etc.
8. An element to be connected to the single data cable 5. This element, the network switch, shall be selected from the group consisting of a direct connection to the internet, a local area network, a router, a switch, and a wide area network.
9. A 2 post rack.
10. A shelf.
11. A 2 piece connector.
12. A cable piece of the 2 piece connector
13. A termination port piece of the 2 piece connector
14. A termination port

The present invention is a multiport media converter 1 that accommodates at least 24 termination ports 2 that allows up to at least 24 end users 7 to access a network using a single output port 3. Alternatively, the media converter 1 may be modified to accommodate 48, 96, 144, or 192 termination ports 2 on the media converter 1 to allow more end users 7 to access the network. Data cables 4 compatible to connect to the termination ports 2 of the media converter 1 comprise twisted pair copper cables. Furthermore, the data cables 4 are selected from the group consisting of CAT5E cables, CAT6A, and CAT6 cables. The termination ports 2 are placed on one side of the media converter 1, while the output port 3 and the test port 6 are positioned on the opposite end. This design comprises the external presentation of the media converter 1.

The testing port 6 is a tool the network provider can use to check for open ports on the connection. It also functions as a way to determine whether the network is set up correctly or if the server is being blocked by a firewall. The output port 3 is used in the normal operations of the network service and is the port that provides network access. The media converter 1 is capable of converting signal from a number of data cables to a single data cable 5. This allows the media converter 1 to provide network access through the termination ports 2. Depending on the type of network the business provides, the output port 3 of the media port 1 will be connected to a single data cable 5 that is attached to a network switch 8 selected from the group consisting of LAN, WAN, cloud, or wireless network. This setup of a single cable 5 attached to a network switch 8 that directly connects to the output port 3 combines the two panel process of the prior art, thereby eliminating any need for a standard horizontal wire management system and minimizing the need for vertical wire management system.

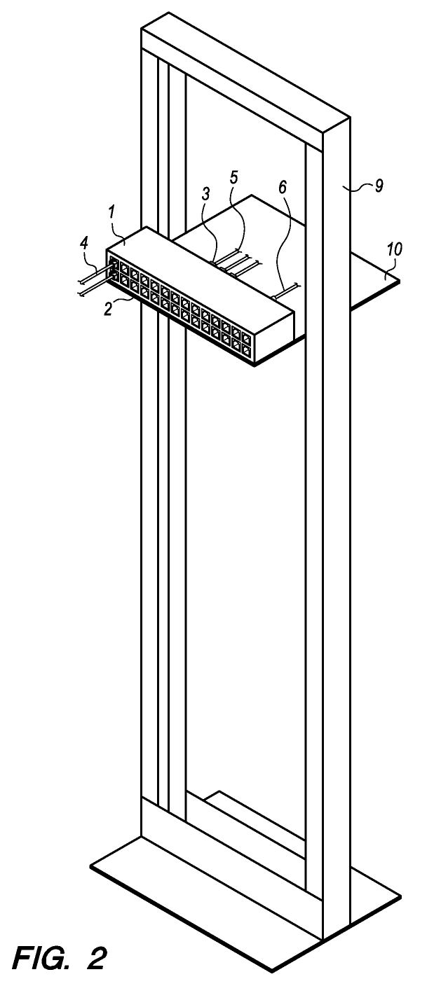

Referring to FIG. 2, a number of data cables 4 compatible to connect to the termination ports 2 are connected to a number of end users 7. The end users 7 can be an office work station, university computer lab, etc. From the perspectives of the end users 7, the front side of the media converter 1 is the termination port 2. From the perspective of the network provider, the front side of the media converter 1 is the output port 3 and testing port 6. The data cables 4 connect to the end users' 7 computers and provide access to the network from data the network switch 8 transmits trough the single cable 5. The media converter 1 serves as a bridge between the data from the network switch 8 and the end users 7.

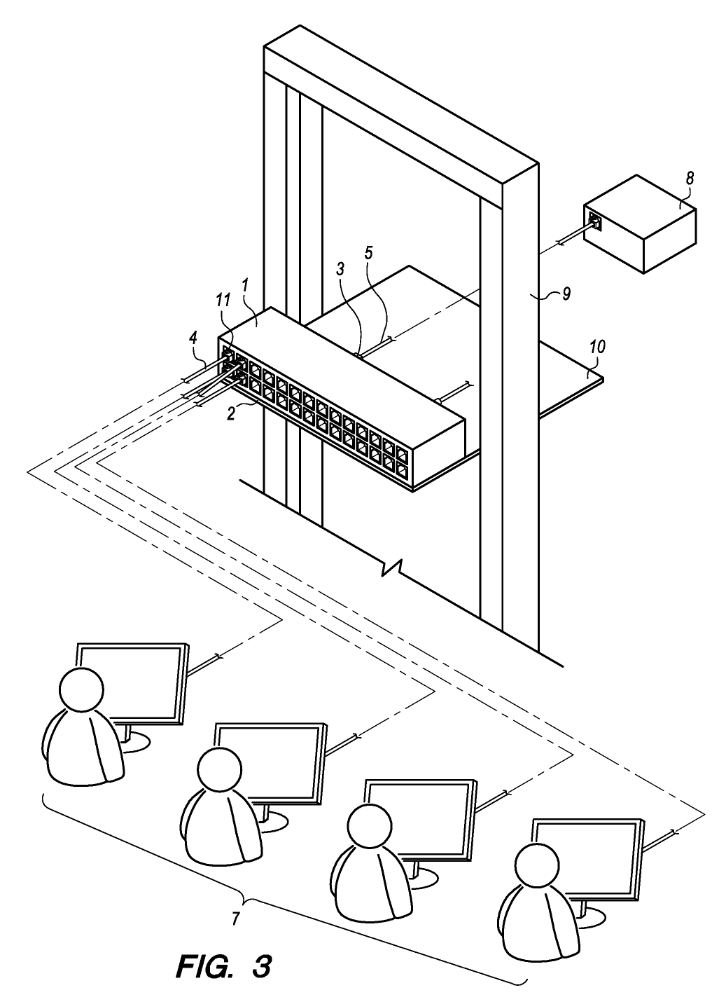

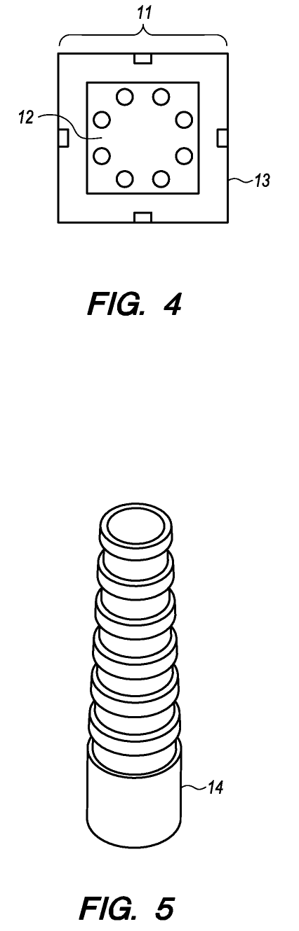

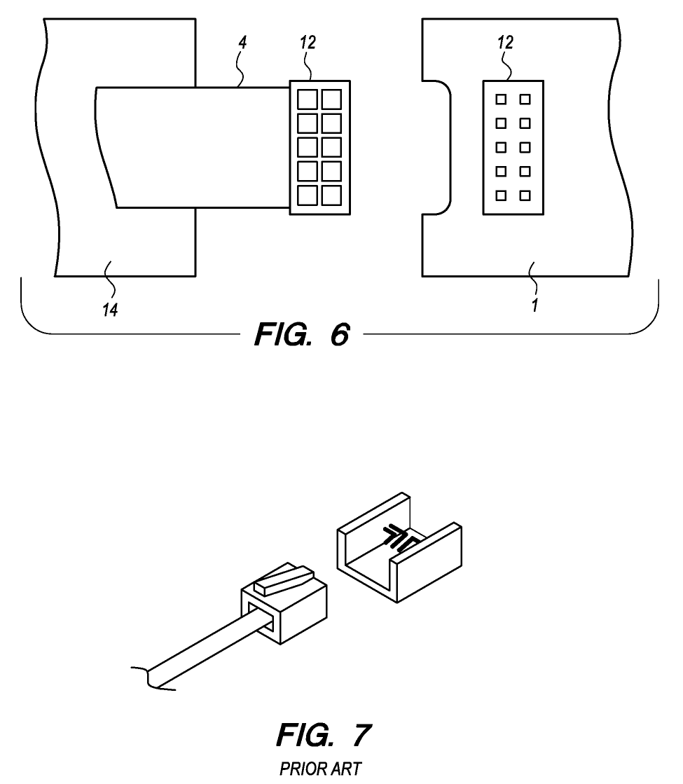

With reference to FIG. 3, the media converter 1 is built into a shelf 10 capable of supporting and holding a media converter 1 and all its components wherein the data from the network switch 8 ultimately reaches the end users 7. This entire setup comprises the data cable management system. The shelf 10 with the media converter 1 inside allows for the output port 3, test port 6, and at least 24 termination ports 2 to be accessed from the outside, thereby allowing the connection between the output port 3 to the single data cable 5 and the connection between a number of data cables 4 compatible to the termination ports 2. The shelf 10 itself is further secured between a 2 post rack 9, or a 4 post lockable cabinet. The enclosed setup of the data cable management system significantly reduces the amount of cabling involved in the prior art, thereby enhances the organization and appearance of the network equipment.

The media converter 1 within the shelf 10, collectively referred to as the data cable management system, is attached by a 2 piece connector that connects the data cables 4 compatible to connect to the termination ports 2 to a CPU circuit board. This 2 piece connector may be attached and removed from the CPU circuit board for the testing of individual ports. To optimize space for the data cables 4 to reach the termination ports 2, the 2 piece connector has a outer base piece measuring ⅜ inch diameter and a ¼ inch inner piece. The data cables 4 are coated by a hard plastic strain relief collar to protect the cables from strain when the 2 piece connector is removed or inserted.

To test the data cable management system, the media converter 1 requires at least one test port 6 capable of connecting to one or more data cables 4 at one end, and a second end capable of connecting the data cables 4 to each of the end users 7. A multi-media testing device is needed to determine whether the network is functioning properly. A multi-media device is an instrument with connector cabling that tests for voice, data, and video application supports. It is commonly a handheld device with a LCD display. To test the network, the remote end of the multi-media device connects to the test port 6 of the media converter 1 and the smart end of the multi-media testing device connects to the second end of one of the data cables 4. Repeat the step of connecting the smart end of the multi-media testing device to the second end of each of the data cables 4 connected to the termination ports 2 can determine whether the network is working properly for each end user 7.

Although the present invention has been explained in relation to its preferred embodiment, it is to be understood that many other possible modifications and variations can be made without departing from the spirit and scope of the present invention.

What is claimed is:

1. A multiport media converter comprising:
a. a media converter having at least 24 termination points and a single output port;
b. the media converter being capable of converting signal from a number of data cables to a single data cable;
c. wherein the number is 24 or greater.

2. The multiport media converter of claim 1, wherein the data cables comprise twisted pair copper cables.

3. The multiport media converter of claim 1, wherein the data cables are selected from the group consisting of CAT5E cables, CAT6A, and CAT6 cables.

4. The multiport media converter of claim 1, wherein the single data cable comprises a duplex fiber-optic cable.

5. The multiport media converter of claim 1, wherein the single date cable comprises a 10 gigabyte Cat 6A cable.

6. The multiport media converter of claim 1, wherein the number is 24.

7. The multiport media converter of claim 1, wherein the number is 48.

8. The multiport media converter of claim 1, wherein the number is 96.

9. The multiport media converter of claim 1, wherein the number is 144.

10. The multiport media converter of claim 1, wherein the number is 192.

11. The multiport media converter of claim 1, wherein the media converter has at least one test port whereby a correct installation of each data cable may be tested.

12. A data cable management system comprising:
a. a media converter capable of converting signal from a number of data cables to a single data cable, wherein the number is 24 or greater.
b. wherein the plurality of data cables connect a plurality of end users to the media converter;
c. the single data cable is connected an element selected from the group consisting of a direct connection to the internet, a local area network, a router, a switch, and a wide area network thereby eliminating any need for a standard horizontal wire management system and thereby minimizing the need for a vertical wire management system.

13. The data cable management system of claim 12, wherein the media converter has at least one test port.

14. The data cable management system of claim 12, further comprising a rack and at least one shelf, the shelf being capable of supporting a media converter capable of converting signal from a number of data cables to a single data cable, wherein the number is 24 or greater.

15. The data cable management system of claim 14, wherein the system is built into the shelf.

16. The data cable management system of claim 13, wherein the rack is selected from the group consisting of a 2 post rack and a 4 post lockable cabinet.

17. The data cable management system of claim 12, further comprising a 2 piece connector which connects the plurality of data cables to a CPU circuit board.

18. The data cable management system of claim 17, wherein the 2 piece connector having
a. a cable connector piece attached to one of the plurality of data cables; and
b. a termination port piece located inside a termination port of the CPU circuit board, thereby optimizing space for data cable terminations.

19. The data cable management system of claim 18, wherein the cable connector piece has a diameter of ⅜ of an inch.

20. The data cable management system of claim 18, wherein the termination port piece has a diameter of ¼ of an inch.

21. The data cable management system of claim 17, wherein the 2 piece connector may be attached and removed from the CPU circuit board for testing individual ports.

22. The data cable management system of claim 17, further comprising a hard plastic strain relief collar installed over the plurality of data cables thereby protecting the plurality of data cables from strain when the 2 piece connecter is removed or inserted.

23. The data cable management system of claim 22, wherein the hard plastic strain relief collar further comprises a base adapted to attach to and remove from the 2 piece connector.

24. A method of testing one or more data cables comprising:
a. providing a media converter having at least one a test port, the media converter being connected to a one or more data cables at a first end of the data cables, a second end of each of the data cables are capable of connecting to an end user;
b. providing a multi-media testing device having a smart end and a remote end and having a test head of the type selected from the group consisting of a link test head and a channel test head;
c. connecting the remote end of the multi-media testing device to the test port of the media converter;
d. connecting the smart end of the multi-media testing device to the second end of one of the data cables.

25. The method of claim 24, further comprising the step of connecting the smart end of the multi-media testing device to the second end of each of the data cables.
